(19) United States
(12) Patent Application Publication
(10) Pub. No.: US 2008/0055531 A1
(43) Pub. Date: Mar. 6, 2008

(54) Liquid Crystal Display and Method for Fabricating the Same

(75) Inventors: Jung-Hsiang Lin, Hsin-Chu (TW); Shu-Chin Lee, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 11/688,499

(22) Filed: Mar. 20, 2007

(30) Foreign Application Priority Data
Sep. 4, 2006 (TW) 95132605

(51) Int. Cl. G02F 1/1339

(52) U.S. Cl. 349/155

(57) ABSTRACT

A liquid crystal display and a method for fabricating the same are provided. The liquid crystal display has a thin-film transistor (TFT) array substrate, a color filter substrate with a plurality of bumps, and a liquid crystal layer sealed between the TFT array substrate and the color filter substrate. When the sealing process is performed, the bumps are pressed and deformed so that the contact area between the bumps and the TFT array substrate increases.

This application claims priority to Taiwan Application Serial Number 95132605, filed Sep. 4, 2006, which is herein incorporated by reference.

### BACKGROUND

1. Field of Invention

The present invention relates to a liquid crystal display and method for fabricating the same. More particularly, the present invention relates to a liquid crystal display and method for fabricating the same by using a liquid crystal one drop filling (ODF) process.

2. Description of Related Art

Currently, a one drop filling (ODF) process is used as a new generation liquid crystal manufacturing technique. The ODF process is used widely for liquid crystal mass production because of its advantage of largely shortening the time of liquid crystal filling process.

The ODF process is performed for fabricating a color filter substrate by using an ink jet technique. The ODF process is described in detail as follows. First, a black matrix mask frame is provided on a glass substrate for defining a pixel area. A plurality of sub pixel areas of the pixel area are drop filled with a colored photo-resist material respectively. The colored photo-resist is then hardened to form the color filter substrate. However, the thickness of the black matrix mask frame is larger than the thickness of the color filter substrate. There is accordingly a gap recess trough formed in the black matrix mask frame. Next, an over-coating layer is formed for filling the gap recess trough by using a planarization process. Then spacers are formed on the over-coating layer for providing liquid crystal cell spacers, which is used for defining a plurality of liquid crystal cells. The liquid crystal cells are drop filled with a liquid crystal material to form the color filter substrate. A thin-film transistor (TFT) array substrate and the color filter substrate are sealed to form a liquid crystal display panel.

### SUMMARY

The present invention is directed to a liquid crystal display and a method for fabricating the same by using a liquid crystal one drop filling (ODF) process.

It is therefore an aspect of the present invention to provide a liquid crystal display panel. According to an embodiment of the present invention, the liquid crystal display panel at least comprises a thin-film transistor (TFT) array substrate, a color filter substrate having a plurality of protrusions, and a liquid crystal layer sealed between the TFT array substrate and the color filter substrate. When sealing the TFT array substrate and the color filter substrate, at least part of the protrusions are pressed and deformed for increasing the contact area between the protrusions and the TFT array substrate.

It is another aspect of the present invention to provide a liquid crystal display panel. According to another embodiment of the present invention, the liquid crystal display panel at least comprises a TFT array substrate, a color filter substrate having a plurality of protrusions for supporting the TFT array substrate, and a liquid crystal layer sealed between the TFT array substrate and the color filter substrate. When sealing the TFT array substrate and the color filter substrate, at least part of the protrusions are pressed and deformed for increasing the strength of protrusions for supporting the TFT array substrate. Every protrusion may have a bump on the top surface. The protrusions can be spacers or are formed on the black matrix.

It is still another aspect of the present invention to provide a liquid crystal display panel. According to another embodiment of the present invention, the liquid crystal display panel at least comprises a TFT array substrate, a color filter substrate, and a liquid crystal layer sealed between the TFT array substrate and the color filter substrate. The TFT array substrate comprises a first bump and a second bump. The color filter substrate comprises a first protrusion and a second protrusion. A colored photo-resist layer is formed between the first protrusion and the second protrusion. The first bump contacts the first protrusion, while the second bump does not contact the second protrusion. The protrusions also can be spacers.

It is still another aspect of the present invention to provide a liquid crystal display panel. According to another embodiment of the present invention, the liquid crystal display panel at least comprises a TFT array substrate having a display area and a plurality bumps, the bumps formed in the display area. A color filter substrate includes a plurality of protrusions, and a liquid crystal layer is sealed between the TFT array substrate and the color filter substrate. The ratio that the total contact area of the bumps compares the display area is from 0.02% to 0.8%, preferably, the ratio that the total contact area of the bumps compares the display area is from 0.02% to 0.2%. The protrusions also can be spacers. A thickness of one of the bumps is between about 0.3 μm and 0.8 μm, preferably is 0.5 μm.

It is the other aspect of the present invention to provide a method for fabricating a liquid crystal display panel. The method for fabricating a liquid crystal display panel at least comprises the steps of: providing a TFT array substrate; providing a color filter substrate having a plurality protrusions for supporting the TFT array substrate; drop filling a liquid crystal material on the color filter substrate to form a liquid crystal layer between the TFT array substrate and the color filter substrate, wherein the top surface of the liquid crystal layer is higher than the top surface of the protrusions; and pressing and sealing the TFT array substrate and the color filter substrate, wherein at least part of the protrusions are pressed and deformed to increase the strength of the protrusions for supporting the TFT array substrate.

In accordance with the foregoing embodiments of the present invention, the protrusions could be formed on a glass substrate of the color filter substrate directly. In addition, the protrusions could be formed on a liquid crystal alignment protrusion of multi-domain vertical alignment (MVA) process, or the MVA liquid crystal alignment protrusion could be the protrusion itself.

These and other features, aspects, and advantages of the present invention will become better understood with reference to the following description, figures, and appended claims.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings, it is noticed that the variety of structures are not drawn according to their real size for the industrial applications. Instead, the size of the structures could be changed for clearly description of the invention.

FIG. 1 is a cross-section diagram illustrating a liquid crystal display panel according to an embodiment of the present invention;

FIGS. 2A and 2B are cross-section diagrams illustrating a liquid crystal display panel according to another embodiment of the present invention;

FIG. 3 is a cross-section diagram illustrating a pressed and sealed liquid crystal display panel according to FIG. 1 of the present invention;

FIG. 4 is a cross-section diagram illustrating a pressed and sealed liquid crystal display panel according to FIGS. 2A and 2B of the present invention; and

FIG. 5 is a cross-section diagram illustrating a liquid crystal display panel according to another embodiment of the present invention.

### DESCRIPTION OF THE PREFERRED EMBODIMENTS

Reference will now be made in detail to the present preferred embodiments of the invention, examples of which are illustrated in the accompanying drawings. The embodiments and examples herein are used for illustrating the features of the present invention clearly. Wherever possible, the same reference numbers are used in the drawings and the description to refer to the same or like parts.

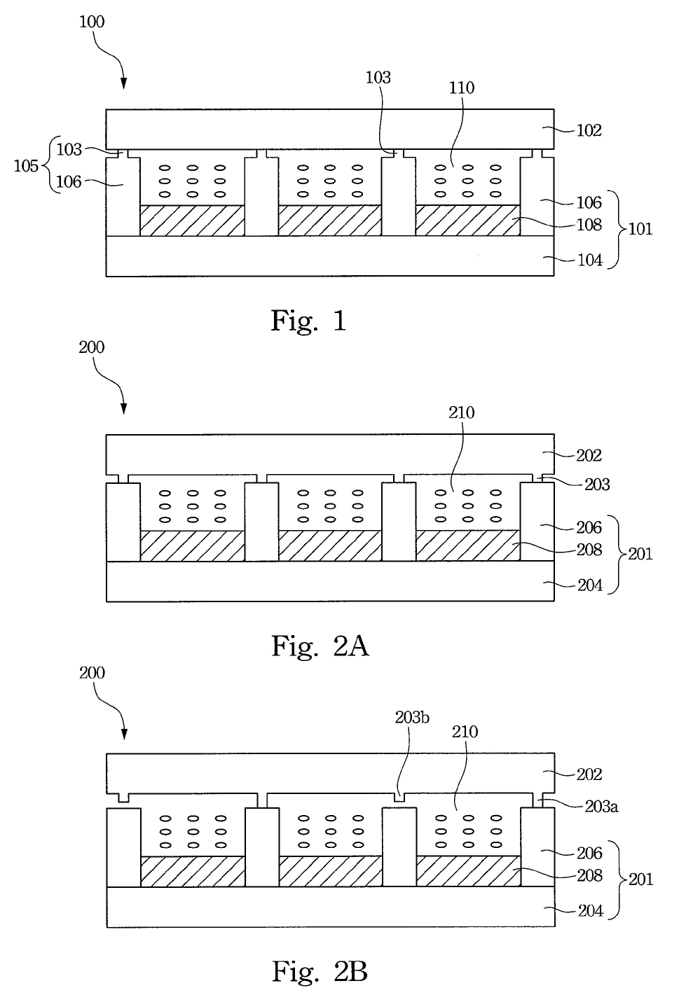

A liquid crystal display and a method for fabricating the same by using a liquid crystal one drop filling (ODF) process are provided. Referring to FIG. 1, a cross-section diagram illustrates a liquid crystal display panel 100 according to an embodiment of the present invention. The liquid crystal display panel 100 at least comprises a thin-film transistor (TFT) array substrate 102, a color filter substrate 101, and a liquid crystal layer 110 sealed between the TFT array substrate 102 and the color filter substrate 101. The color filter substrate 101 includes a glass substrate 104 and a plurality of spacers 105. Every spacer 105 has a protrusion 106 and a bump 103 formed on the protrusion 106. The plurality of spacers 105 are set on the glass substrate 104 and form a black matrix mask frame. The spacers 105 act as supporters between the TFT array substrate 102 and the color filter substrate 101. A pixel recess trough is formed in a pixel area, which is defined by the spacers 105 and set between the TFT array substrate 102 and the color filter substrate 101. A plurality of sub pixel recess troughs of the pixel recess trough are drop filled with a plurality of Red, Green and Blue photo-resist materials respectively to form a variety of colored photo-resist layers 108 by using ink jet technique. The top surface of the colored photo-resist layers 108 differs from the top surface of the protrusions 106 with a height of about 1˜5 μm (micro-meter). Furthermore, a plurality of bumps 103 are selectively formed on the top surface of the protrusions 106. The thickness of the bumps 103 is between about 0.3 μm and 0.8 μm, preferred about 0.5 μm. The top area of the bumps 103 is smaller than the top area of the protrusions 106. The foresaid bumps 103 and the protrusions 106 could be formed simultaneously or respectively.

Referring to FIG. 1 again, the pixel recess trough is drop filled with a liquid crystal material to form a liquid crystal layer 110. When the bumps 103 are formed on the protrusions 106, the height of the liquid crystal layer 110 is between the height of the bumps 103 and the height of the protrusions 106. The amount that the bumps 103 is higher than the liquid crystal layer 110 could be reserved for following deformation of the protrusions 106 during sealing process.

Next, a process for sealing the TFT array substrate 102 and the color filter substrate 101 is performed. The ratio that the total contact area of the spacers 105 (or the bumps 103) and the TFT array substrate 102 compares the pixel area (the display area) is from 0.02% to 0.8%, preferably, the ratio is from 0.02% to 0.2%. There is a de-vacuuming process after the liquid crystal one drop filling (ODF) process. After the de-vacuuming process, the TFT array substrate 102 and the color filter substrate 101 could be sealed under the Atmosphere. The total contact area of the spacers 105 (or the bumps 103) contacting the TFT array substrate 102 and the color filter substrate 101 can not resist the Atmosphere, so that the spacers 105 (or the protrusions 106) are pressed and deformed to increase the contact area and strength of the spacers 105 (or protrusions 106) for resisting the Atmosphere. The deformation amount of the spacers 105 (or the bumps 103) is preferred 0.2˜1 μm.

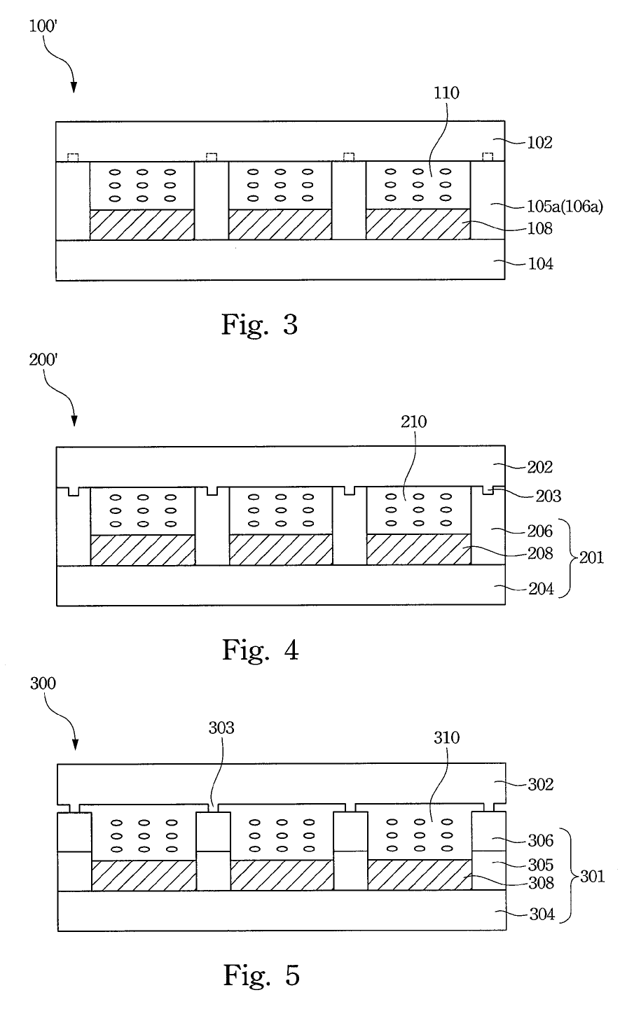

Referring to FIG. 3, a cross-section diagram illustrates a pressed and sealed liquid crystal display panel 100′ according to FIG. 1 of the present invention. As shown in FIG. 3, the bumps 103a are pressed and deformed under the Atmosphere. The protrusions 106 accordingly become a plurality of deformed protrusions 106a. The bumps 103 shown in FIG. 1 could be partly pressed (not shown) or wholly pressed (shown in FIG. 3). The deformation of the spacers 105 (or the protrusions 106) increases the contact area between the deformed spacers 105a (or the deformed protrusions 106a) and the TFT array substrate 102 for resisting the Atmosphere. The TFT array substrate 102 and the color filter substrate 101 are then sealed by using ultraviolet (UV) light glue. When sealing the TFT array substrate 102 and the color filter substrate 101, at least part of the protrusions 106 could be pressed and deformed to increase the contact area between the deformed spacers 105a (or the deformed protrusions 106a) and the TFT array substrate 102 for improving the resist strength of the spacers 105 (or the protrusions 106).

Referring to FIGS. 2A and 2B, cross-section diagrams illustrate a liquid crystal display panel according to another embodiment of the present invention. Referring to FIG. 2A, a liquid crystal display panel 200 comprises at least a TFT array substrate 202, a color filter substrate 201, and a liquid crystal layer 210 sealed between the TFT array substrate 202 and the color filter substrate 201. The color filter substrate 201 includes a glass substrate 204 and a plurality of spacers 206 set on the glass substrate 204. The spacers 206 could be protrusions. The spacers 206 can form a black matrix mask frame. The spacers 206 are supporters between the TFT array substrate 202 and the color filter substrate 201. A pixel recess trough is formed in a pixel area, which is defined by the spacers 206. A plurality of sub pixel recess troughs of the pixel recess trough are drop filled with a plurality of Red, Green and Blue photo-resist materials respectively to form a variety of colored photo-resist layers 208 by using ink jet technique. The top surface of the colored photo-resist layers 208 is lower than the top surface of the protrusions 206 with a height of about 1˜5 μm. A plurality of bumps 203 are formed on the surface of the TFT array substrate 202. The material of the bumps 203 is preferred silicon oxide, silicon nitride, silicon nitrogen-oxide, and a stacked layer of the conducting metal layer and any other layer of the TFT array substrate 202, or the combined material of any aforementioned materials. The top area of the bumps 203 is smaller than the top area of the spacers 206. The thickness of the bump 203 is between about 0.3 μm and 0.8 μm, preferably is 0.5 μm.

Next, the pixel recess trough is drop filled with a liquid crystal material to form a liquid crystal layer 210. The top surface of the liquid crystal layer 210 is higher than the top surface of the spacers 206 with a height of about 0.25˜1 μm. Since the height of the liquid crystal layer 210 is lower than the height of the frame glue around the color filter substrate 201 (not shown), and the liquid crystal layer 210 flows very slowly because of its high surface tension, the liquid crystal layer 210 will not overflow.

A process for sealing the TFT array substrate 202 and the color filter substrate 201 is performed. The bumps 203 of the TFT array substrate 202 contact the spacers 206 of the color filter substrate 201. The ratio that the total contact area of the spacers 206 (or the bumps 203) compares the pixel area (the display area) is from 0.02% to 0.8%, preferably, the ratio is from 0.02% to 0.2%. Referring to FIG. 2B, the other embodiment of the present invention, the bumps 203 are with different height. For example, a bump 203a is thick (high) because of having a TFT transistor, while a bump 203b is thin (low). Accordingly, not all of the bumps 203 could contact the spacers 206 during sealing the TFT array substrate 202 and the color filter substrate 201. The thick bump 203a could contact the spacers 206, while the thin bump 203b does not contact the spacers 206. The ratio that the total contact area of the spacers 206 (or the bumps 203) compares the pixel area (the display area) still remains from 0.02% to 0.8%, preferably, the ratio is from 0.02% to 0.2%. The height of the top surface of the liquid crystal layer 210 is half of the height of the spacers 206 during sealing the TFT array substrate 202 and the color filter substrate 201.

Referring to FIG. 4, a cross-section diagram illustrates a pressed and sealed liquid crystal display panel 200′ according to FIGS. 2A and 2B of the present invention. After de-vacuuming process of the liquid crystal one drop filling (ODF) process, the TFT array substrate 202 and the color filter substrate 201 could be sealed under the Atmosphere. The total contact area of the bumps 203 the TFT array substrate 202 and the spacers 206 of the color filter substrate 201 can not resist the Atmosphere, so that the bumps 203 are pressed into the spacers 206 because the bumps 203 are harder than the spacers 206. As shown in FIG. 4, the contact area of the TFT array substrate 202 and the spacers 206 increases for resisting the Atmosphere. The bumps 203 could be partly pressed (not shown) or wholly pressed (shown in FIG. 4). The deformation amount of the spacers 206 is preferred 0.2˜1 μm. When sealing the TFT array substrate 202 and the color filter substrate 201, at least part of the spacers 206 could be pressed and deformed to increase the contact area between the spacers 206 and the TFT array substrate 202 for improving the resist strength of the spacers 206.

The spacers 206 could be formed not only on the glass substrate, but also on a liquid crystal alignment protrusion of multi-domain vertical alignment (MVA) process. Furthermore, the MVA liquid crystal alignment protrusion could be the spacers 206 directly. Referring to FIG. 5, a cross-section diagram illustrates a liquid crystal display panel according to another embodiment of the present invention. A liquid crystal display panel 300 at least comprises a TFT array substrate 302, a color filter substrate 301, and a liquid crystal layer 310 sealed between the TFT array substrate 302 and the color filter substrate 301. The color filter substrate 301 comprises a plurality of MVA liquid crystal alignment protrusions 306 (or spacers 306) and a black matrix mask frame 305, wherein the MVA liquid crystal alignment protrusions 306 (or the spacers 306) are formed on the black matrix mask frame 305. The spacers 306 also can be protrusions. The black matrix mask frame 305 could be the liquid crystal alignment protrusions. The MVA liquid crystal alignment protrusions 306 are supporters between the TFT array substrate 302 and the color filter substrate 301. A pixel recess trough is formed in a pixel area, which is defined by the MVA liquid crystal alignment protrusions 306 and set between the TFT array substrate 302 and the color filter substrate 301. A plurality of sub pixel recess troughs of the pixel recess trough are drop filled with a plurality of Red, Green and Blue photo-resist materials respectively to form a variety of colored photo-resist layers 308 by using ink jet technique. The top surface of the colored photo-resist layers 308 differs from (is lower than) the top surface of the MVA liquid crystal alignment protrusions 306 with a height of about 1˜5 μm. A plurality of bumps 303 are formed on the surface of the TFT array substrate 302. The material of the bumps 303 is preferred silicon oxide, silicon nitride, silicon nitrogen-oxide, and a stacked layer of the conducting metal layer and the other layer of the TFT array substrate 302, or the combined material of any aforementioned materials. The thickness of the bump 303 is between about 0.3 μm and 0.8 μm, preferably is 0.5 μm. The bumps 303 of FIG. 5 could be designed the same as the bumps 203 of FIG. 2B. In addition, as shown in FIG. 1, the bumps 303 could be formed on the MVA liquid crystal alignment protrusions 306, and the TFT array substrate 302 is the same as the TFT array substrate 102 of FIG. 1. The embodiments of the present invention are not limited in FIG. 5, all of the foregoing structures of the TFT array substrate and the protrusions could be used in this embodiment of FIG. 5. In this embodiment of FIG. 5, the top surface of the colored photo-resist layers 308 differs from (is lower than) the top surface of the MVA liquid crystal alignment protrusions 306 with a height of about 1˜5 μm after the colored photo-resist layers 308 is formed.

According the embodiments of the present invention, a planarization process could be omitted or selectively used for forming a covering layer to fill the foregoing recess troughs. A spacer is then formed on the covering layer to provide liquid crystal spacers. The prior liquid crystal one drop filling (ODF) process is accordingly simplified to reduce the manufacturing cost and improve the production yield. In addition, the protrusions include not only the black matrix mask frame or the liquid crystal alignment protrusions, but also spacers formed by spacer process or ink jet technique. The material of the protrusions is preferred photoresist material. The protrusions could be formed on the liquid crystal alignment protrusions or the black matrix mask frame.

Generally speaking, the prior process for sealing the TFT array substrate and the color filter substrate directly may result in some problems of vacuum bubble or non-uniform luminance. In accordance with the foregoing embodiments of the present invention, the protrusions could be deformed for preventing the TFT array substrate from contacting the liquid crystal layer directly during sealing the TFT array substrate and the color filter substrate. The sealing process is performed under the Atmosphere, and the problems of vacuum bubble and non-uniform luminance could be eliminated by way of the deformed protrusions. The deformed protrusions could result in supporting force enough to increase the pressure endurance and vibration resistance of the liquid crystal display panel.

Although the present invention has been described in considerable detail with reference to certain preferred embodiments thereof, other embodiments are possible. Their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display panel, comprising:
a TFT array substrate having a display area, wherein the TFT array substrate comprises a plurality of bumps formed in the display area;
a color filter substrate disposed opposite to the TFT array substrate, having a plurality of protrusions; and
a liquid crystal layer disposed between the TFT array substrate and the color filter substrate,
wherein a thickness of one of the bumps is between about 0.3 μm and 0.8 μm, and the one of the bumps is contact with one of the protrusions.

2. The liquid crystal display panel of claim 1, further comprising at least one black matrix formed on the color filter substrate.

3. The liquid crystal display panel of claim 1, further comprising a colored photo-resist layer formed between the protrusions.

4. The liquid crystal display panel of claim 3, wherein a height of the protrusions is higher than that of the colored photo-resist layer about 1˜5 μm.

5. The liquid crystal display panel of claim 1, wherein the protrusion is a black matrix or a liquid crystal alignment protrusion.

6. The liquid crystal display panel of claim 1, wherein the cross section area of the bump is smaller than that of the protrusion.

7. The liquid crystal display panel of claim 1, wherein the material of the bumps is comprised of silicon oxide, silicon nitride, silicon nitrogen-oxide, metal, and the combinations thereof.

8. The liquid crystal display panel of claim 1, wherein the thickness of one of the bumps is about 0.5 μm.

9. A liquid crystal display panel, at least comprising:
a TFT array substrate having a display area;
a color filter substrate disposed opposite to the TFT array substrate, having a plurality of spacers, wherein each of the spacers has a protrusion and a bump formed on the protrusion, wherein a thickness of one of the bumps is between about 0.3 μm and 0.8 μm; and
a liquid crystal layer disposed between the TFT array substrate and the color filter substrate.

10. The liquid crystal display panel of claim 9, further comprising at least one black matrix formed on the color filter substrate.

11. The liquid crystal display panel of claim 9, further comprising a colored photo-resist layer formed between the protrusions.

12. The liquid crystal display panel of claim 11, wherein a height of the protrusions is higher than that of the colored photo-resist layer about 1˜5 μm.

13. The liquid crystal display panel of claim 9, wherein the protrusion is a black matrix or a liquid crystal alignment protrusion.

14. The liquid crystal display panel of claim 9, wherein the cross section area of the bump is smaller than that of the protrusion.

15. The liquid crystal display panel of claim 9, wherein the material of the bumps is comprised of silicon oxide, silicon nitride, silicon nitrogen-oxide, metal and the combinations thereof.

16. The liquid crystal display panel of claim 9, wherein the thickness of one of the bumps is about 0.5 μm.

17. A liquid crystal display panel, comprising:
a TFT array substrate, comprising:
a first bump; and
a second bump;
a color filter substrate, comprising:
a first protrusion;
a second protrusion; and
a colored photo-resist layer formed between the first protrusion and the second protrusion; and
a liquid crystal layer disposed between the TFT array substrate and the color filter substrate,
wherein the first bump contacts the first protrusion, while the second bump does not contact the second protrusion.

18. The liquid crystal display panel of claim 15, wherein the first bump includes a thin-film transistor (TFT).

19. A method for fabricating a liquid crystal display panel, comprising:
providing a TFT array substrate having a display area, wherein the TFT array substrate comprises a plurality of bumps formed in the display area;
providing a color filter substrate having a plurality protrusions for supporting the TFT array substrate;
dropping a liquid crystal material on at least one of the color filter substrate and the TFT array substrate to form a liquid crystal layer between the TFT array substrate and the color filter substrate;
sealing the liquid crystal layer between the TFT array substrate and the color filter substrate to form a liquid crystal display panel; and
pressing the liquid crystal display panel, so that at least part of the bumps are pressed into the protrusions.

20. The method of claim 19, further comprising forming a colored photo-resist layer formed between the protrusions after the step of providing the color filter substrate having the plurality protrusions for supporting the TFT array substrate.

21. The method of claim 20, wherein a height of the protrusions is higher than that of the colored photo-resist layer about 1˜5 μm.

22. The method of claim 19, wherein a thickness of one of the bumps is between about 0.3 μm and 0.8 μm.

23. The method of claim 19, wherein a deformation amount of the protrusion is about 0.2˜1 μm.

24. A method for fabricating a liquid crystal display panel, comprising:
providing a TFT array substrate having a display area;
providing a color filter substrate having a plurality of spacers, wherein each of the spacers has a protrusion and a bump formed on the protrusion;
dropping a liquid crystal material on at least one of the color filter substrate and the TFT array substrate to form a liquid crystal layer between the TFT array substrate and the color filter substrate;
sealing the liquid crystal layer between the TFT array substrate and the color filter substrate to form a liquid crystal display panel; and
pressing the liquid crystal display panel, so that at least part of the bumps are deformed.

25. The method of claim 24, further comprising forming a colored photo-resist layer formed between the protrusions after the step of providing the color filter substrate.

26. The method of claim 25, wherein a height of the protrusions is higher than that of the colored photo-resist layer about 1˜5 μm.

27. The method of claim 24, wherein a thickness of the bump is between about 0.3 μm and 0.8 μm.

28. The method of claim 24, wherein a deformation amount of the protrusion is 0.2˜1 μm.
